(19) United States
(12) Patent Application Publication
(10) Pub. No.: US 2019/0375052 A1
(43) Pub. Date: Dec. 12, 2019

(54) LASER PROCESSING APPARATUS

(71) Applicant: DISCO CORPORATION, Tokyo (JP)

(72) Inventors: Yuji HADANO, Tokyo (JP); Keiji NOMARU, Tokyo (JP)

(21) Appl. No.: 16/430,684

(22) Filed: Jun. 4, 2019

(30) Foreign Application Priority Data
Jun. 11, 2018 (JP) 2018-110972

(51) Int. Cl. B23K 26/40; H01S 3/10; B23K 26/16

(52) U.S. Cl. CPC B23K 26/40; B23K 26/16; H01S 3/10

(57) ABSTRACT

A laser processing apparatus includes a holding unit having a holding table holding a plate-shaped workpiece, a laser beam applying unit applying a pulsed laser beam to the workpiece held on the holding table to thereby process the workpiece, and a liquid supply mechanism supplying a liquid to the workpiece held on the holding table to provide a condition where the workpiece is immersed in the liquid. The liquid supply mechanism includes a chamber having a transparent plate located above the holding table with a spacing defined between the lower surface of the transparent plate and the upper surface of the workpiece held on the holding table, the chamber being held on the upper surface of the holding unit to define an enclosed space.

### BACKGROUND OF THE INVENTION

### Field of the Invention

The present invention relates to a laser processing apparatus for applying a pulsed laser beam to a plate-shaped workpiece to process the workpiece.

### Description of the Related Art

A plurality of devices such as integrated circuits (ICs) and large scale integrations (LSIs) are formed on the front side of a wafer so as to be separated by a plurality of crossing division lines formed on the front side of the wafer. The wafer thus having the plural devices on the front side is divided along the division lines by using a laser processing apparatus to obtain a plurality of individual device chips respectively including the plural devices. These device chips are used in various electrical equipment such as mobile phones, personal computers, and illumination equipment.

There are various types of laser processing methods using a laser processing apparatus. For example, the following types (1), (2), and (3) are known in the art.

(1) A laser beam having an absorption wavelength to a workpiece is applied to the workpiece in the condition where the focal point of the laser beam is set on the front side (upper surface) of the workpiece, thereby performing ablation to form a groove as a division start point on the front side of the workpiece along each division line (see Japanese Patent Laid-Open No. Hei 10-305420, for example).

(2) A laser beam having a transmission wavelength to a workpiece is applied to the workpiece in the condition where the focal point of the laser beam is set inside the workpiece, thereby forming a modified layer as a division start point inside the workpiece along each division line (see Japanese Patent No. 3408805, for example).

(3) A laser beam having a transmission wavelength to a workpiece is applied to the workpiece in the condition where the focal point of the laser beam is set at a predetermined position inside the workpiece, thereby forming a plurality of shield tunnels as a division start point in the workpiece along each division line, in which each shield tunnel is composed of a fine hole and an amorphous region formed around the fine hole for shielding the fine hole, and the fine hole extends from the front side of the workpiece to the back side thereof (see Japanese Patent Laid-Open No. 2014-221483, for example).

Any one of these laser processing methods is suitably selected according to the kind of the workpiece and the processing accuracy demanded, for example.

In the above-mentioned type (1) that the ablation is performed, debris (laser processing dust) is generated in applying the laser beam to the front side of the workpiece (wafer), and this debris scatters and adheres to the front side of each device formed on the front side of the wafer, causing a possible degradation in quality of each device. To cope with this problem, the following method has been proposed. That is, a liquid resin allowing the transmission of the laser beam to be used for processing is previously applied to the front side of the wafer prior to performing the laser processing, thereby preventing the adherence of the debris to the front side of the wafer. After performing the laser processing, the liquid resin (resin film) is removed (see Japanese Patent Laid-Open No. 2004-188475, for example).

### SUMMARY OF THE INVENTION

According to the technique described in Japanese Patent Laid-Open No. 2004-188475, the adherence of the debris to the front side of each device can be prevented by the liquid resin (resin film) applied to the front side of the wafer, so that the processing quality can be ensured. However, it is necessary to perform a step of applying the liquid resin to the wafer before performing the laser processing and a step of removing the liquid resin from the wafer after performing the laser processing. Further, the liquid resin cannot be repeatedly used. Accordingly, there are problems in productivity and in economy.

Further, another method may be such that the wafer is immersed in water before performing the laser processing and the debris generated by the application of the laser beam is allowed to float in the water, thereby preventing the adherence of the debris to the front side of the wafer. However, bubbles are generated in the water by the application of the laser beam, and the laser beam is hindered by the bubbles in processing the wafer, so that desired laser processing cannot be performed.

It is therefore an object of the present invention to provide a laser processing apparatus which can prevent the adherence of the debris to the front side of the workpiece and can also prevent the hindrance of the application of the pulsed laser beam due to the bubbles.

In accordance with an aspect of the present invention, there is provided a laser processing apparatus including a holding unit having a holding table holding a plate-shaped workpiece, a laser beam applying unit applying a pulsed laser beam to the workpiece held on the holding table to thereby process the workpiece, and a liquid supply mechanism supplying a liquid to the workpiece held on the holding table to provide a condition where the workpiece is immersed in the liquid. The liquid supply mechanism includes a chamber having a transparent plate located above the holding table with a spacing defined between a lower surface of the transparent plate and an upper surface of the workpiece held on the holding table, the chamber being placed on the upper surface of the holding unit to define an enclosed space, liquid supplying means supplying the liquid into the enclosed space of the chamber to make the flow of the liquid through the spacing, liquid discharging means discharging the liquid from the enclosed space of the chamber, and restriction means restricting the flow of the liquid from the liquid discharging means to increase a pressure in the chamber in the condition where the enclosed space of the chamber is filled with the liquid, thereby compressing bubbles generated in the liquid by the application of the pulsed laser beam to the workpiece. The laser beam applying unit includes a laser oscillator oscillating a pulsed laser and generating the pulsed laser beam, and focusing means focusing the pulsed laser beam generated from the laser oscillator and applying the pulsed laser beam through the transparent plate and the liquid present in the spacing to the workpiece held on the holding table.

Preferably, the laser beam applying unit further includes dispersing means dispersing a laser applying position where the pulsed laser beam is applied to the workpiece. Preferably, the pressure in the chamber is maintained at 6 to 10 atmospheres.

According to the present invention, the adherence of debris generated in laser processing can be prevented without the need for coating of the front side of a wafer with a liquid resin, so that a cost for the liquid resin can be cut. Further, it is unnecessary to perform the step of coating the front side of the workpiece with the liquid resin, so that the productivity can be improved. Further, the bubbles generated in the liquid by the application of the pulsed laser beam can be compressed by the increased pressure of the liquid, so that the application of the pulsed laser beam is not hindered by the bubbles, but desired laser processing can be performed.

The above and other objects, features and advantages of the present invention and the manner of realizing them will become more apparent, and the invention itself will best be understood from a study of the following description and appended claims with reference to the attached drawings showing a preferred embodiment of the invention.

### BRIEF DESCRIPTION OF THE DRAWINGS

FIG. 1 is a perspective view of a laser processing apparatus according to a preferred embodiment of the present invention;

FIG. 2 is a perspective view of a part of a liquid supply mechanism and holding means included in the laser processing apparatus depicted in FIG. 1, in which the part of the liquid supply mechanism is exploded;

FIG. 3 is a perspective view of the whole of the liquid supply mechanism and the holding means;

FIG. 4 is a perspective view of a laser beam applying unit included in the laser processing apparatus depicted in FIG. 1;

FIG. 5 is an exploded perspective view of the laser beam applying unit depicted in FIG. 4;

FIG. 6 is a block diagram depicting an optical system included in the laser beam applying unit depicted in FIG. 4;

FIG. 7 is a perspective view depicting a condition where laser processing is performed to a wafer by the laser beam applying unit depicted in FIG. 5; and

FIG. 8 is a side view of the laser beam applying unit for illustrating the laser processing depicted in FIG. 7.

### DETAILED DESCRIPTION OF THE PREFERRED EMBODIMENT

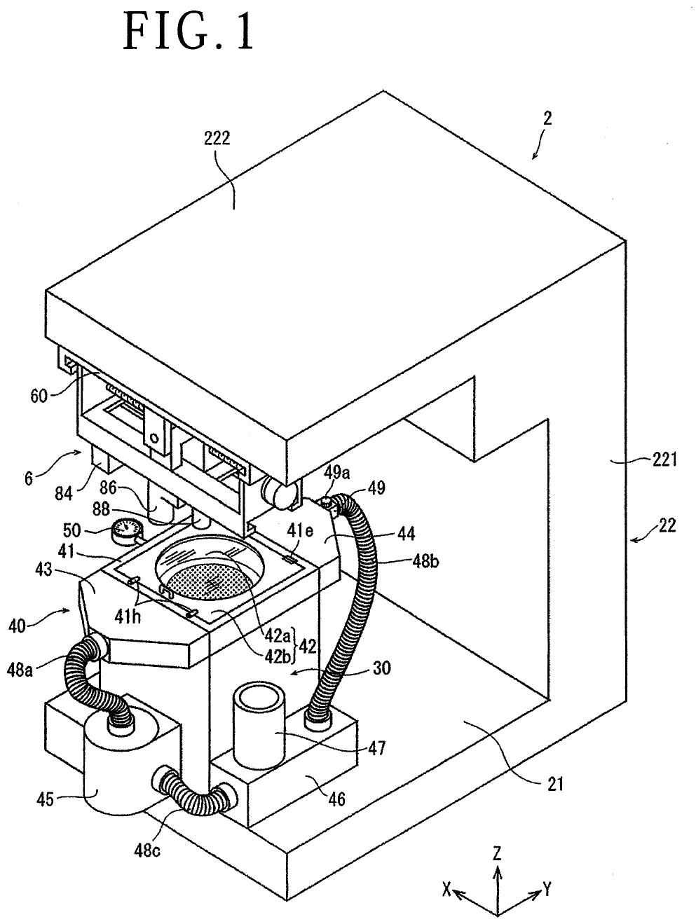

A laser processing apparatus according to a preferred embodiment of the present invention will now be described in detail with reference to the attached drawings. FIG. 1 is a perspective view of a laser processing apparatus 2 according to this preferred embodiment. The laser processing apparatus 2 includes a base 21, holding means 30 provided on the base 21 for holding a plate-shaped workpiece, an inverted L-shaped support member 22 composed of a vertical portion 221 extending upward from the rear end of the base 21 in a Z direction depicted by an arrow Z in FIG. 1 at a position behind the holding means (holding unit) 30 and a horizontal portion 222 extending horizontally from the upper end of the vertical portion 221 toward a position above the holding means 30, a liquid supply mechanism 40 for forming a space capable of accommodating the workpiece held by the holding means 30, supplying a liquid into this space, and discharging the liquid supplied into this space, and a laser beam applying unit 6 provided on the lower surface of the horizontal portion 222 of the support member 22.

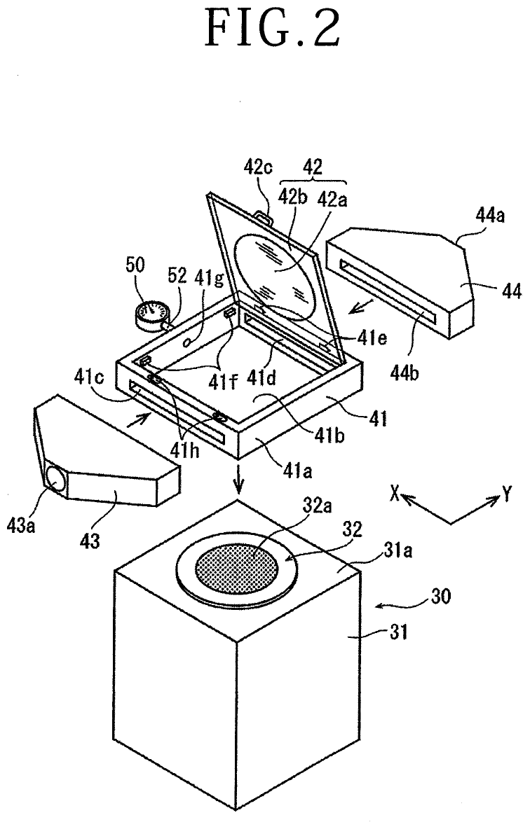

FIG. 2 is a perspective view depicting the holding means 30 and the liquid supply mechanism 40, in which the liquid supply mechanism 40 is exploded to depict a chamber 41, a liquid supply nozzle 43, and a liquid discharge nozzle 44 as components.

The holding means 30 includes a box-shaped holding base 31 fixed to the upper surface of the base 21 and a circular holding table 32 provided on an upper surface 31a of the holding base 31. The holding table 32 is rotatable about its vertical axis by a rotating mechanism (not depicted). The holding table 32 has a central circular area functioning as a vacuum chuck 32a formed of a material having gas permeability, such as porous ceramic. The vacuum chuck 32a is connected to a vacuum source (not depicted), so that the plate-shaped workpiece placed on the vacuum chuck 32a can be held under suction by operating the vacuum source.

As depicted in FIG. 2, the chamber 41 is placed on the upper surface 31a of the holding base 31. The chamber 41 is composed of a rectangular frame 41a for forming a rectangular space 41b opening at its upper and lower ends and a rectangular cover plate 42 for closing the upper opening of the space 41b. The frame 41a has four side walls composed of a pair of parallel side walls opposed to each other in a Y direction depicted by an arrow Y in FIG. 2 and another pair of parallel side walls opposed to each other in an X direction depicted by an arrow X in FIG. 2. One of the two parallel side walls opposed to each other in the Y direction is formed with a liquid supply opening 41c for making the communication of the space 41b of the frame 41a with the outside of the frame 41a, whereas the other side wall is formed with a liquid discharge opening 41d for making the communication of the space 41b of the frame 41a with the outside of the frame 41a. That is, the liquid discharge opening 41d is opposed to the liquid supply opening 41c. Each of the liquid supply opening 41c and the liquid discharge opening 41d is a rectangular opening elongated in the X direction, and has a size (length in the X direction) larger than the diameter of the vacuum chuck 32a. Further, of the frame 41a, one of the other two parallel side walls opposed to each other in the X direction is formed with a hole 41g, and a pressure gauge 50 is connected through the hole 41g to the space 41b of the frame 41a (the chamber 41). The pressure gauge 50 may be a known pressure gauge capable of measuring the pressure in the space 41b of the chamber 41 and displaying the pressure measured. The pressure gauge 50 may be of a mechanical type or a digital type.

The cover plate 42 is composed of a circular transparent plate 42a for covering the holding table 32 with a spacing defined therebetween and a frame plate 42b for supporting the outer circumference of the transparent plate 42a. The transparent plate 42a may be a glass plate. The frame plate 42b may be a stainless steel plate. The transparent plate 42a and the frame plate 42b function to cooperatively close the upper opening of the space 41b of the frame 41a. That is, the frame plate 42b has substantially the same outer shape and size as those of the space 41b as viewed in plan. That is, the frame plate 42b is adapted to just fit in the space 41b of the frame 41a. The cover plate 42 is pivotably supported through two hinges 41e to the frame 41a, so that the upper opening of the space 41b of the frame 41a can be opened and closed by pivotally moving the cover plate 42. In the closed condition of the cover plate 42, the transparent plate 42a is opposed to the holding table 32. Each side wall of the frame 41a is provided with a plurality of step portions 41f for supporting the cover plate 42. More specifically, the plural step portions 41f are provided on the inner surface of each side wall of the frame 41a. Further, the cover plate 42 is provided with a handle portion 42c adapted to be grasped in opening and closing the cover plate 42. More specifically, the handle portion 42c is provided on the upper surface of the cover plate 42 at a front end portion thereof. Further, the frame 41a is provided with a pair of cover plate locking members 41h for locking the cover plate 42 in its closed condition. More specifically, in the closed condition of the cover plate 42 as depicted in FIG. 1, each cover plate locking member 41h is engaged with the cover plate 42 to thereby lock the cover plate 42 in its closed condition. Each cover plate locking member 41h is pivotably mounted on the upper end surface of the frame 41a so as to be rotatable about a vertical axis. Accordingly, by rotating each cover plate locking member 41h in the closed condition of the cover plate 42, the front end portion of each cover plate locking member 41h comes into engagement with the upper surface of the cover plate 42, thereby locking the cover plate 42 in its closed condition. The chamber 41 having the above configuration is located on the upper surface 31a of the holding base 31 in such a manner that the cover plate 42 in its closed condition is opposed to the holding table 32.

As depicted in FIG. 2, the liquid supply nozzle 43 is connected to the frame 41a in its one side wall formed with the liquid supply opening 41c. The liquid supply nozzle 43 functions as liquid supplying means for supplying a liquid W (e.g., pure water) into the chamber 41 to increase the pressure in the chamber 41. Further, the liquid discharge nozzle 44 is connected to the frame 41a in its another side wall formed with the liquid discharge opening 41d. The liquid discharge nozzle 44 functions as liquid discharging means for discharging the liquid W from the chamber 41. Both the liquid supply nozzle 43 and the liquid discharge nozzle 44 are substantially triangular as viewed in plan. The thickness of each of the liquid supply nozzle 43 and the liquid discharge nozzle 44 is substantially the same as that of the chamber 41.

The liquid supply nozzle 43 has an inlet opening 43a from which the liquid W is supplied. The liquid supply nozzle 43 has an inside passage (not depicted) for guiding the liquid W supplied from the inlet opening 43a to the liquid supply opening 41c of the chamber 41. The liquid supply nozzle 43 has an outlet opening (not depicted) from which the liquid W is discharged. This outlet opening of the liquid supply nozzle 43 is opposed to the liquid supply opening 41c of the chamber 41. This outlet opening of the liquid supply nozzle 43 has the same shape and size as those of the liquid supply opening 41c of the chamber 41. Accordingly, the liquid W supplied from the inlet opening 43a of the liquid supply nozzle 43 is guided through the inside passage and the outlet opening of the liquid supply nozzle 43 to the liquid supply opening 41c of the chamber 41.

The liquid discharge nozzle 44 has the same shape and size as those of the liquid supply nozzle 43. As depicted in FIG. 2, the liquid discharge nozzle 44 has an inlet opening 44b from which the liquid W is allowed to enter and an outlet opening 44a from which the liquid W is discharged. The liquid discharge nozzle 44 has an inside passage (not depicted) for guiding the liquid W from the inlet opening 44b to the outlet opening 44a. The inlet opening 44b of the liquid discharge nozzle 44 is opposed to the liquid discharge opening 41d of the chamber 41. The inlet opening 44b has the same shape and size as those of the liquid discharge opening 41d. The liquid W introduced from the inlet opening 44b of the liquid discharge nozzle 44 is guided through the inside passage of the liquid discharge nozzle 44 to the outlet opening 44a of the liquid discharge nozzle 44, and is then discharged from the outlet opening 44a. A gasket (not depicted) is provided on the lower end surface of the frame 41a of the chamber 41 along the entire periphery of the frame 41a. Accordingly, when the chamber 41 is placed on the upper surface 31a of the holding base 31 in the closed condition of the cover plate 42, the space 41b is substantially enclosed by the chamber 41 and the upper surface 31a of the holding base 31 in a sealed condition.

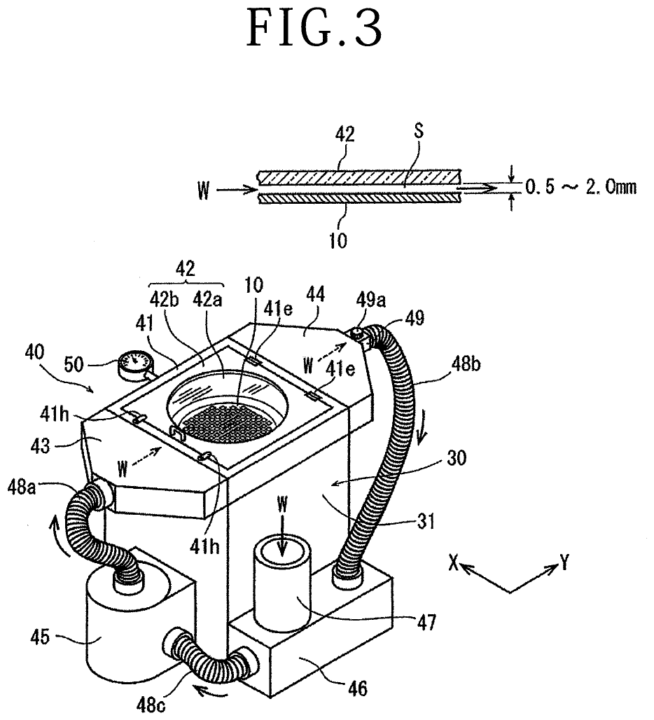

The liquid supply mechanism 40 will now be described more specifically with reference to FIG. 3. FIG. 3 depicts a condition where a wafer 10 as a plate-shaped workpiece is held on the holding table 32 of the holding means 30 under suction and the chamber 41 is placed on the upper surface 31a of the holding base 31 of the holding means 30, in which a plurality of devices are formed on the front side of the wafer 10 so as to be separated from each other by a plurality of crossing division lines formed on the front side of the wafer 10. In an upper area of FIG. 3, there is depicted an enlarged sectional view of an essential part of the configuration that a spacing S of approximately 0.5 to 2.0 mm is defined between the wafer 10 held on the holding table 32 of the holding means 30 and the lower surface of the transparent plate 42a of the cover plate 42. The liquid supply mechanism 40 further includes a liquid supply pump 45, a liquid filter unit 46, and a liquid storage tank 47 in addition to the chamber 41, the liquid supply nozzle 43, and the liquid discharge nozzle 44 mentioned above. The liquid storage tank 47 is provided on the liquid filter unit 46. The liquid supply pump 45 is connected through a first hose 48a to the liquid supply nozzle 43. The liquid discharge nozzle 44 is connected through a second hose 48b to the liquid filter unit 46. The liquid filter unit 46 is connected through a third hose 48c to the liquid supply pump 45. All of the first, second, and third hoses 48a, 48b, and 48c are flexible hoses formed of resin (plastic). Further, a pressure adjusting valve 49 as restriction means is provided at the joint between the liquid discharge nozzle 44 and the second hose 48b.

The liquid W raised from the liquid supply pump 45 is supplied through the first hose 48a and the liquid supply nozzle 43 into the chamber 41. The liquid W thus supplied into the chamber 41 is discharged through the liquid discharge nozzle 44 and the second hose 48b. The liquid W thus discharged through the second hose 48b is allowed to enter the liquid filter unit 46 for filtration of the liquid W. The liquid W filtered by the liquid filter unit 46 is returned to the liquid supply pump 45.

Thus, the liquid supply mechanism 40 includes the liquid supply pump 45, the liquid filter unit 46, and the liquid storage tank 47 to circulate the liquid W in the liquid supply mechanism 40 in this preferred embodiment. However, such a configuration for circulating the liquid W is not always necessary in the liquid supply mechanism 40 according to the present invention. For example, in a plant where a plurality of processing apparatuses are installed, there is a case that a common liquid source is provided to supply the liquid W (cleaning water) to all the processing apparatuses under the same conditions, and a common filter unit is provided to recover the liquid W used for the processing in all the processing apparatuses and then remove environmental pollutant from the liquid W. Further, a common liquid recovering path is provided in the plant in some case to return the liquid W to the common liquid source after removing the environmental pollutant. Further, there is another case that the liquid W is discharged to the outside of the plant after removing the environmental pollutant from the liquid W in the common filter unit. In the case of installing the laser processing apparatus 2 according to this preferred embodiment in such a plant as mentioned above, the liquid supply mechanism 40 may exclude the liquid supply pump 45, the liquid filter unit 46, and the liquid storage tank 47 to provide a simple configuration.

Referring again to FIG. 3, there is a gap between the lower end surface of the chamber 41 and the upper surface of the holding base 31 and there is also a gap between the cover plate 42 and the frame 41a of the chamber 41. Accordingly, the liquid W supplied into the chamber 41 may gradually leak from these gaps. The liquid W thus leaked is suitably compensated by the liquid W supplied from the liquid storage tank 47. In this manner, the liquid W is circulated in the liquid supply mechanism 40.

The operation of the pressure adjusting valve 49 will now be described in more detail. The liquid W is discharged from the liquid supply pump 45 at a predetermined flow rate and then supplied through the first hose 48a and the liquid supply nozzle 43 into the chamber 41. The pressure adjusting valve 49 is provided at the joint between the liquid discharge nozzle 44 and the second hose 48b. The pressure adjusting valve 49 is provided with an adjusting dial 49a adapted to be rotated. By rotating the adjusting dial 49a, the opening area in the pressure adjusting valve 49 can be adjusted to thereby change a flow resistance in discharging the liquid W from the liquid discharge nozzle 44. As a result, the pressure in the chamber 41 can be increased by operating the adjusting dial 49a of the pressure adjusting valve 49. The chamber 41 is provided with the pressure gauge 50 for measuring the pressure in the chamber 41. Accordingly, the pressured in the chamber 41 can be checked by an operator through the pressure gauge 50. Then, the adjusting dial 49a is rotated by the operator according to the pressure measured by the pressure gauge 50, thereby adjusting the pressure in the chamber 41 to a predetermined pressure, e.g., 6 to 10 atmospheres.

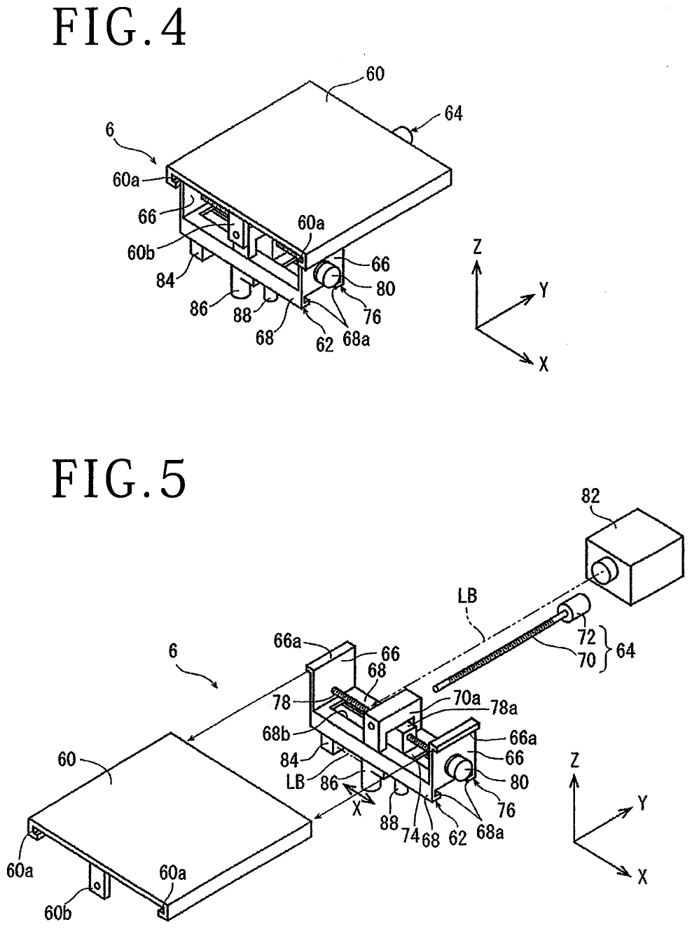

There will now be described the laser beam applying unit 6 with reference to FIGS. 1, 4, and 5. FIG. 5 is an exploded perspective view of the laser beam applying unit 6 depicted in FIG. 4.

The laser beam applying unit 6 includes a rectangular guide plate 60 fixed to the lower surface of the horizontal portion 222 of the support member 22 by fixing means (not depicted), a Y movable member 62 supported to the guide plate 60 so as to be movable in the Y direction, and a Y moving mechanism 64 for moving the Y movable member 62 in the Y direction. A pair of guide rails 60a extending in the Y direction are formed on the lower surface of the guide plate 60 at its opposite ends in the X direction. As depicted in FIGS. 4 and 5, the Y movable member 62 has a pair of guided portions 66 spaced in the X direction and a mounting portion 68 extending in the X direction so as to connect the lower ends of the guided portions 66. A guided rail 66a extending in the Y direction is formed at the upper end of each guided portion 66. The guided rails 66a of the two guided portions 66 are slidably engaged with the guide rails 60a of the guide plate 60, so that the Y movable member 62 is supported to the guide plate 60 so as to be movable in the Y direction.

Further, a pair of guide rails 68a extending in the X direction are formed on the lower surface of the mounting portion 68 at its opposite ends in the Y direction. As depicted in FIG. 5, the Y moving mechanism 64 has a ball screw 70 extending in the Y direction so as to be located below the guide plate 60 and a motor 72 connected to one end of the ball screw 70. The ball screw 70 has an inverted U-shaped nut portion 70a, which is fixed to the upper surface of the mounting portion 68. The other end of the ball screw 70 is threadedly engaged with the nut portion 70a so as to be inserted therethrough. Further, the other end of the ball screw 70 inserted through the nut portion 70a is rotatably supported to a support projection 60b formed at the front end of the guide plate 60. Accordingly, the rotary motion of the motor 72 can be converted into a linear motion by the ball screw 70, and this linear motion can be transmitted to the Y movable member 62. As a result, the Y movable member 62 can be moved in the Y direction along the guide rails 60a of the guide plate 60 by operating the Y moving mechanism 64.

The laser beam applying unit 6 will further be described with reference to FIG. 5. The laser beam applying unit 6 further includes an X movable plate 74 mounted on the mounting portion 68 of the Y movable member 62 so as to be movable in the X direction and an X moving mechanism 76 for moving the X movable plate 74 in the X direction. The opposite ends of the X movable plate 74 in the Y direction are slidably engaged with the guide rails 68a of the mounting portion 68, so that the X movable plate 74 is mounted on the mounting portion 68 so as to be movable in the X direction. The X moving mechanism 76 has a ball screw 78 extending in the X direction so as to be located above the mounting portion 68 and a motor 80 connected to one end of the ball screw 78 and supported to one of the two guided portions 66. The ball screw 78 has a nut portion 78a, which is fixed to the upper surface of the X movable plate 74. The mounting portion 68 has an elongated opening 68b in which the nut portion 78a is movable in the X direction. The other end of the ball screw 78 is rotatably supported to the other guided portion 66. Accordingly, the rotary motion of the motor 80 can be converted into a linear motion by the ball screw 78, and this linear motion can be transmitted to the X movable plate 74. As a result, the X movable plate 74 can be moved in the X direction along the guide rails 68a of the mounting portion 68 by operating the X moving mechanism 76.

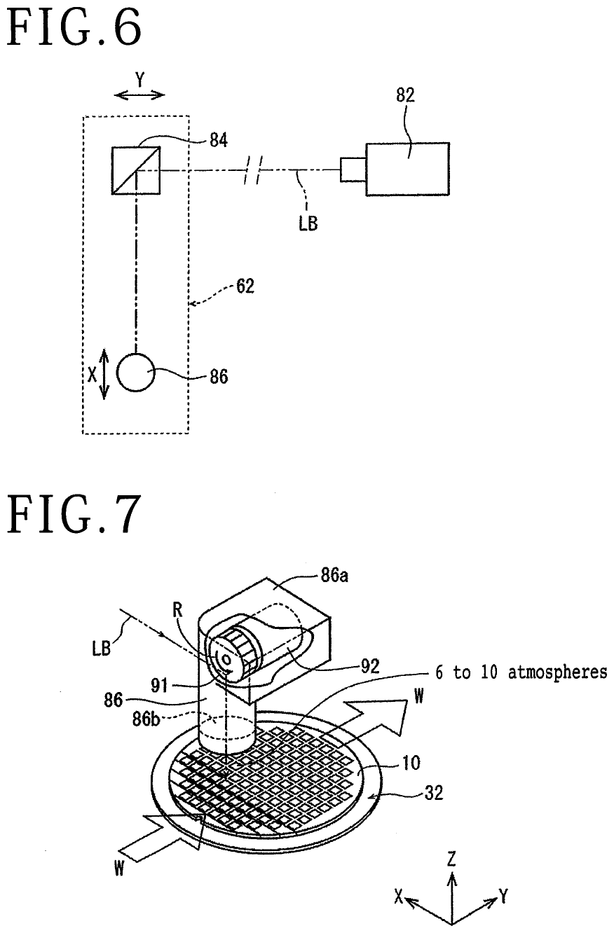

An optical system included in the laser beam applying unit 6 will now be described with reference to FIGS. 5 to 8. As depicted in FIG. 5, the laser beam applying unit 6 further includes a laser oscillator 82 built in the horizontal portion 222 of the support member 22 for oscillating a pulsed laser and outputting a pulsed laser beam LB, an attenuator (not depicted) for adjusting the power of the pulsed laser beam LB generated from the laser oscillator 82, a rectangular prism mirror 84 mounted on the lower surface of the mounting portion 68 of the Y movable member 62 so as to be spaced from the laser oscillator 82 in the Y direction, focusing means 86 mounted on the lower surface of the X movable plate 74 so as to be movable in the Z direction, and focal position adjusting means (not depicted) for moving the focusing means 86 in the Z direction to adjust the Z position of the focal point of the focusing means 86, that is, the vertical position of the focal point of the pulsed laser beam LB to be focused by the focusing means 86. The laser oscillator 82 functions to generate a laser beam LB having an absorption wavelength (e.g., 355 nm) to the workpiece. As depicted in FIG. 6, the rectangular prism mirror 84 functions to change the traveling direction of the laser beam LB generated from the laser oscillator 82 by 90 degrees and then direct the laser beam LB toward the focusing means 86. That is, the traveling direction of the laser beam LB generated from the laser oscillator 82 is changed from the Y direction to the X direction by the rectangular prism mirror 84.

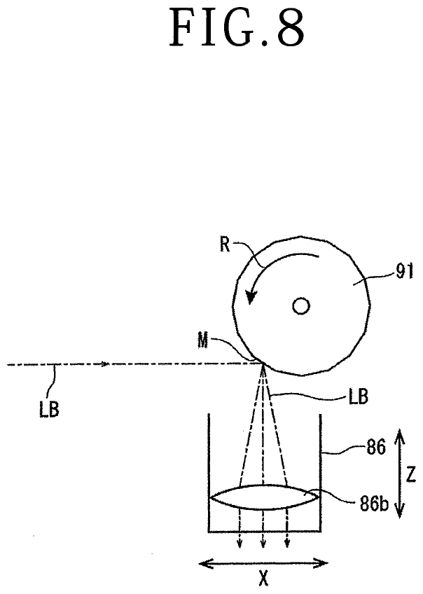

As depicted in FIG. 7, the focusing means 86 has a housing 86a containing a polygon mirror 91 as dispersing means for dispersing (deflecting) the laser beam LB generated from the laser oscillator 82 and next reflected by the rectangular prism mirror 84, a motor 92 for rotating the polygon mirror 91 at a high speed in the direction depicted by an arrow R in FIG. 7, and a focusing lens (fθ lens) 86b for focusing the laser beam LB reflected by the polygon mirror 91 and then applying the laser beam LB to the workpiece. As depicted in FIG. 8, the polygon mirror 91 includes a plurality of mirrors M concentrically arranged about the rotation axis of the polygon mirror 91. That is, the plural mirrors M are so arranged as to form a regular polygon about the rotation axis of the polygon mirror 91 as viewed in side elevation. The fθ lens 86b is located below the polygon mirror 91 and functions to focus the laser beam LB reflected by the polygon mirror 91 toward the workpiece held on the holding table 32. The laser beam LB reflected by the rectangular prism mirror 84 is allowed to enter the polygon mirror 91, and the laser beam LB is next dispersed in its traveling direction by the plural mirrors M rotating about the axis of the polygon mirror 91. That is, the traveling direction of the laser beam LB reflected by each mirror M is dispersed in the X direction in a predetermined range. Then, the laser beam LB dispersed by each mirror M of the polygon mirror 91 is applied to the workpiece in the predetermined range.

Referring back to FIG. 5, alignment means 88 is also mounted on the lower surface of the X movable plate 74 so as to be spaced from the focusing means 86 in the X direction. The alignment means 88 functions to image the workpiece held on the holding table 32 and detect a target area to be laser-processed. Further, the focal position adjusting means (not depicted) included in the laser beam applying unit 6 may be so configured as to have a ball screw (not depicted) extending in the Z direction and a motor (not depicted) connected to one end of the ball screw, in which the ball screw has a nut portion fixed to the focusing means 86. The focal position adjusting means is operated in such a manner that the rotary motion of the motor is converted into a linear motion by the ball screw, and this linear motion is transmitted to the focusing means 86. Accordingly, the focusing means 86 can be moved in the Z direction along a guide rail (not depicted), so that the Z position of the focal point of the laser beam LB to be focused by the focusing means 86 can be adjusted.

The operation of the laser processing apparatus 2 configured above will now be described. First, the wafer 10 formed of silicon (Si) as a plate-shaped workpiece is prepared. A plurality of devices are previously formed on the front side of the wafer 10 so as to be separated from each other by a plurality of crossing division lines composed of a plurality of parallel division lines extending in a first direction and a plurality of parallel division lines extending in a second direction perpendicular to the first direction. Thereafter, the cover plate 42 depicted in FIG. 1 is opened and the wafer 10 is next placed on the vacuum chuck 32a of the holding table 32 in the condition where the front side of the wafer 10 is oriented upward. Thereafter, the vacuum source (not depicted) connected to the vacuum chuck 32a is operated to apply a suction force to the vacuum chuck 32a, thereby holding the wafer 10 on the vacuum chuck 32a under suction. Thereafter, the cover plate 42 is closed and locked by the cover plate locking members 41h (see FIG. 3).

After holding the wafer 10 on the vacuum chuck 32a and closing the cover plate 42 as mentioned above, the liquid supply pump 45 of the liquid supply mechanism 40 is operated in the condition where a sufficient amount of liquid W is stored in the liquid storage tank 47. For example, pure water is used as the liquid W to be circulated in the liquid supply mechanism 40.

When a predetermined period of time has elapsed after starting the operation of the liquid supply mechanism 40, the space 41b of the chamber 41 is filled with the liquid W, because the pressure adjusting valve 49 is previously operated to restrict the flow of the liquid W at the outlet of the liquid discharge nozzle 44, thereby adjusting the pressure in the chamber 41 to 6 to 10 atmospheres. As a result, the liquid W can be stably circulated in the liquid supply mechanism 40.

In the condition where the liquid W is stably circulated in the liquid supply mechanism 40 as mentioned above, the X moving mechanism 76 of the laser beam applying unit 6 is operated to move the X movable plate 74 in the X direction, and the Y moving mechanism 64 of the laser beam applying unit 6 is also operated to move the Y movable member 62 in the Y direction (see FIGS. 4 and 5), thereby positioning the alignment means 88 above the transparent plate 42a of the cover plate 42. As mentioned above, the transparent plate 42a is set above the holding table 32 in an area where the whole of the holding table 32 can be seen through the transparent plate 42a from the upper side thereof. Accordingly, the whole of the front side of the wafer 10 held on the holding table 32 can be imaged through the transparent plate 42a by the alignment means 88. After positioning the alignment means 88 above the wafer 10, the alignment means 88 is operated to image the division lines as a target area to be laser-processed on the wafer 10. At this time, the division lines are imaged through the transparent plate 42a and the liquid W present between the transparent plate 42a and the wafer 10. Thereafter, according to an image obtained by the alignment means 88, alignment is made between the division lines of the wafer 10 and the focusing means 86. That is, by rotating the holding table 32, operating the X moving mechanism 76 to move the X movable plate 74, and operating the Y moving mechanism 64 to move the Y movable member 62, the division lines extending in the first direction on the wafer 10 are made parallel to the X direction, and the focusing means 86 is positioned directly above one end of a predetermined one of the division lines extending in the first direction, that is, directly above a start position where the laser beam LB starts to be applied to the wafer 10. Thereafter, the focal position adjusting means is operated to move the focusing means 86 in the Z direction, thereby positioning the focal point on the upper surface (front side) of the wafer 10 at the above-mentioned one end of the predetermined division line.

After positioning the focal point on the upper surface of the wafer 10 as mentioned above, the laser oscillator 82 in the laser beam applying unit 6 is operated to generate a laser beam LB. At the same time, the X moving mechanism 76 is operated to move the X movable plate 74 in the X direction at a predetermined feed speed. Thus, the laser beam LB is applied to the wafer 10 along the predetermined division line. At this time, as described above with reference to FIGS. 7 and 8, the polygon mirror 91 is rotated at a suitable speed by the motor 92. By rotating the polygon mirror 91, the mirrors M composing the polygon mirror 91 are changed in position, so that the laser beam LB reflected by the mirrors M is dispersed to be applied to the wafer 10. That is, the laser beam LB is scanned in the X direction. After the laser beam LB is reflected by any one of the mirrors M, the laser beam LB is next reflected by the adjacent mirror M formed on the downstream side of the previous mirror M in the rotational direction R depicted in FIG. 8. Thus, the wafer 10 is processed by the laser beam LB along the predetermined division line extending in the X direction. Such laser processing by using each mirror M is repeated while the laser beam LB is being generated from the laser oscillator 82 and the polygon mirror 91 is being rotated. The number of mirrors M composing the polygon mirror 91 and the rotational speed of the polygon mirror 91 may be suitably decided according to the workpiece.

For example, the laser processing by the laser processing apparatus 2 may be performed under the following conditions.

Wavelength of the laser beam: 226 nm, 355 nm, 532 nm, 1064 nm

Average power: 10 to 100 W

Repetition frequency: 0 to 300 MHz

Pulse width: 50 fs to 1 ns

Feed speed: 10 to 1000 mm/s

In this preferred embodiment, the chamber 41 is placed on the holding table 32, and the liquid W always flows at a predetermined velocity in the Y direction perpendicular to the X direction as a feeding direction as depicted in FIG. 7. Furthermore, the pressure in the chamber 41 is maintained at a pressure of 6 to 10 atmospheres (In FIG. 7, the chamber 41 and the cover plate 42 are not depicted for convenience of illustration). In this condition, the laser beam LB is applied from the focusing means 86 through the transparent plate 42a and the liquid W to the predetermined division line on the wafer 10, thereby performing ablation to the wafer 10 along the predetermined division line.

In performing the ablation on the front side of the wafer 10, there is a possibility that bubbles may be generated in the liquid W at the position where the laser beam LB is applied. To cope with this possibility, the liquid W is made to always flow at a predetermined velocity in the spacing S defined between the wafer 10 and the cover plate 42 (see FIG. 3). Furthermore, the pressure in the chamber 41 is maintained at a high pressure of 6 to 10 atmospheres. Accordingly, the bubbles generated in the vicinity of the position where the laser beam LB is applied can be quickly compressed to disappear in the chamber 41. Substantially, the generation of bubbles in the vicinity of the position where the laser beam LB is applied can be prevented. Accordingly, in the case of using the polygon mirror 91 to dispersively apply the laser beam LB to the wafer 10, the laser beam LB can be applied to the wafer 10 without the hindrance by the bubbles due to the ablation. Furthermore, even when debris is generated due to the ablation, the debris released in the liquid W can be quickly removed from the chamber 41 by the continuous flow of the liquid W in the chamber 41. The debris removed from the chamber 41 can be filtered off by the liquid filter unit 46 in the liquid supply mechanism 40. Accordingly, there is no possibility that the debris may be returned to the chamber 41.

After performing the ablation along the predetermined division line, the Y moving mechanism 64 is operated to move the Y movable member 62 in the Y direction by the pitch of the division lines, thereby positioning the focusing means 86 directly above one end of the next division line adjacent to the above predetermined division line. Thereafter, the ablation is similarly performed along this next division line. In this manner, the ablation is similarly performed along all of the other division lines extending in the first direction. Thereafter, the holding table 32 is rotated 90 degrees to make the other division lines extending in the second direction parallel to the X direction. Thereafter, the ablation is similarly performed along all the other division lines extending in the second direction. As a result, the ablation can be performed along all the crossing division lines extending in the first and second directions on the wafer 10.

While the cover plate 42 is composed of the circular transparent plate 42a and the rectangular frame plate 42b formed of stainless steel for holding the outer circumference of the transparent plate 42a in this preferred embodiment, the cover plate 42 may be a rectangular transparent plate. Further, while the transparent plate 42a is a glass plate in this preferred embodiment, the transparent plate 42a may be any transparent plate capable of transmitting the laser beam LB, such as an acrylic resin plate and any other transparent plastic plates.

Further, in the above preferred embodiment, the laser beam LB generated from the laser oscillator 82 is dispersed by the polygon mirror 91 and next guided to the focusing lens 86b. However, the polygon mirror 91 may be replaced by a reflecting mirror fixed in position. Further, while the laser processing for the wafer 10 is ablation in the above preferred embodiment, the laser processing applicable in the present invention may also include laser processing for forming modified layers inside the workpiece (e.g., laser processing described in Japanese Patent No. 3408805) and laser processing for forming so-called shield tunnels inside the workpiece (e.g., laser processing described in Japanese Patent Laid-Open No. 2014-221483).

The present invention is not limited to the details of the above described preferred embodiment. The scope of the invention is defined by the appended claims and all changes and modifications as fall within the equivalence of the scope of the claims are therefore to be embraced by the invention.

What is claimed is:

1. A laser processing apparatus comprising:
a holding unit having a holding table holding a plate-shaped workpiece;
a laser beam applying unit applying a pulsed laser beam to said workpiece held on said holding table to thereby process said workpiece; and
a liquid supply mechanism supplying a liquid to said workpiece held on said holding table to provide a condition where said workpiece is immersed in said liquid;
said liquid supply mechanism including
a chamber having a transparent plate located above said holding table with a spacing defined between a lower surface of said transparent plate and an upper surface of said workpiece held on said holding table, said chamber being placed on the upper surface of said holding unit to define an enclosed space,
liquid supplying means supplying said liquid into said enclosed space of said chamber to make the flow of said liquid through said spacing,
liquid discharging means discharging said liquid from said enclosed space of said chamber, and
restriction means restricting the flow of said liquid from said liquid discharging means to increase a pressure in said chamber in the condition where said enclosed space of said chamber is filled with said liquid, thereby compressing bubbles generated in said liquid by the application of said pulsed laser beam to said workpiece;
said laser beam applying unit including
a laser oscillator oscillating a pulsed laser and generating said pulsed laser beam, and
focusing means focusing said pulsed laser beam generated from said laser oscillator and applying said pulsed laser beam through said transparent plate and said liquid present in said spacing to said workpiece held on said holding table.

2. The laser processing apparatus according to claim 1, wherein
said laser beam applying unit further includes dispersing means dispersing a laser applying position where said pulsed laser beam is applied to said workpiece.

3. The laser processing apparatus according to claim 1, wherein
the pressure in said chamber is maintained at 6 to 10 atmospheres.
